(19) United States
(12) Patent Application Publication
(10) Pub. No.: US 2007/0263153 A1
(43) Pub. Date: Nov. 15, 2007

(54) OCB mode liquid crystal display device with passivation layer of varying height

(75) Inventors: I-An Yao, Miao-Li (TW); Chiu-Lien Yang, Miao-Li (TW); Chueh-Ju Chen, Miao-Li (TW); Hung-Lin Ko, Miao-Li (TW); Jin-Jei Wu, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/803,571

(22) Filed: May 14, 2007

(30) Foreign Application Priority Data
May 12, 2006 (TW) 95116847

(51) Int. Cl. G02F 1/1343; G02F 1/141

(52) U.S. Cl. 349/134; 349/139

(57) ABSTRACT

An exemplary liquid crystal display (LCD) device (2) includes a first substrate (21) and a second substrate (22). A liquid crystal layer (23) having liquid crystal molecules is interposed between the first and second substrates. The liquid crystal molecules are bend-aligned such that the liquid crystal display device is able to operate in an optically compensated bend (OCB) mode. A first alignment layer (219) and a second alignment layer (229) are respectively disposed between the liquid crystal layer and the first and second substrates. A passivation layer (227) is disposed between the second alignment layer and the second substrate, which has different height.

### FIELD OF THE INVENTION

The present invention relates to liquid crystal display (LCD) devices, and more particularly to an OCB (optically compensated bend) mode LCD device having a passivation layer with different heights.

### GENERAL BACKGROUND

In a conventional LCD device, a liquid crystal layer having liquid crystal molecules is sandwiched between a pair of substrates. Transparent electrodes are formed on the two substrates, with the transparent electrodes on one of the substrates facing the transparent electrodes on the other substrate. The transparent electrodes are used to drive the liquid crystal molecules to twist. In such a device, a displaying means known as TN (twisted nematic) displaying is adopted. That is, the LCD device operates by generating an electric field having a direction orthogonal to inner surfaces of the substrates.

However, the TN mode LCD device has a narrow viewing angle, which means that the quality of the display greatly depends on the direction of viewing. In order to obtain a wider viewing angle, the OCB type LCD device has been developed.

A detailed explanation about operation modes of a typical OCB type LCD device is provided hereinbelow, with reference to FIGS. 4 and 5.

As shown in FIG. 4, a typical OCB mode LCD device 1 includes a first substrate 11, a second substrate 12 opposite to the first substrate 11, and a liquid crystal layer 13 disposed between the first substrate 11 and the second substrate 12. A compensation film 111 and a first polarizer 112 are disposed at an upper surface of the first substrate 11, and a second polarizer 122 is disposed at a bottom surface of the second substrate 12. Liquid crystal molecules 131 of the liquid crystal layer 13 are bend-aligned so that the LCD device 1 operates in an optically compensated bend (OCB) mode.

Also referring to FIG. 5, before turning on the LCD device 1, the liquid crystal molecules 131 of the liquid crystal layer 13 are splay aligned. When the LCD device 1 is turned on and before display by the LCD device 1 is commenced, it is necessary to uniformly convert all the liquid crystal molecules 131 from the splay alignment into a bend alignment.

However, the LCD device 1 has the following problems. The transition of the liquid crystal molecules 131 from the splay alignment into the bend alignment may take an unduly long time. That is, the conversion is sluggish, and the LCD device 1 has a correspondingly slow response time. In addition, the transition sometimes does not occur at positions adjacent to boundaries between two adjacent pixel regions of the LCD device 1. When this happens, the LCD device 1 may exhibit display defects.

What is needed, therefore, is an OCB mode LCD device that overcomes the above-described deficiencies.

### SUMMARY

An exemplary liquid crystal display (LCD) device includes a first substrate and a second substrate. A liquid crystal layer having liquid crystal molecules is interposed between the first and second substrates. The liquid crystal molecules are bend-aligned such that the liquid crystal display device is able to operate in an optically compensated bend (OCB) mode. A first alignment layer and a second alignment layer are respectively disposed between the liquid crystal layer and the first and second substrates. A passivation layer is disposed between the second alignment layer and the second substrate, which has different heights.

Another exemplary liquid crystal display device includes a first substrate and a second substrate; a liquid crystal layer having liquid crystal molecules interposed between the first and second substrates the liquid crystal molecules are bend-aligned such that the liquid crystal display device is able to operate in an optically compensated bend (OCB) mode; a plurality of gate lines being parallel to each other and each extending along a first direction, and a plurality of data lines being parallel to each other and each extending along a second direction orthogonal to the first direction. The crossing gate lines and data lines define a plurality of pixel regions corresponding to display regions of the liquid crystal display device, and the gate lines and the data lines are corresponding to non-display regions of the liquid crystal display device. A height of the liquid crystal layer in the display regions is different from a height of the liquid crystal layer in the non-display regions.

Other novel features and advantages will become more apparent from the following detailed description when taken in conjunction with the accompanying drawings. In the drawings, all the views are schematic.

### BRIEF DESCRIPTION OF THE DRAWINGS

FIG. 1 is an exploded, side cross-sectional view of part of an OCB mode LCD device according to a first embodiment of the present invention.

FIG. 2 is an enlarged, top plan view of a corresponding part of a second substrate of the OCB mode LCD device of FIG. 1.

FIG. 3 is an exploded, side cross-sectional view of part of an OCB mode LCD device according to a second embodiment of the present invention.

FIG. 4 is an exploded view of a conventional OCB mode LCD device.

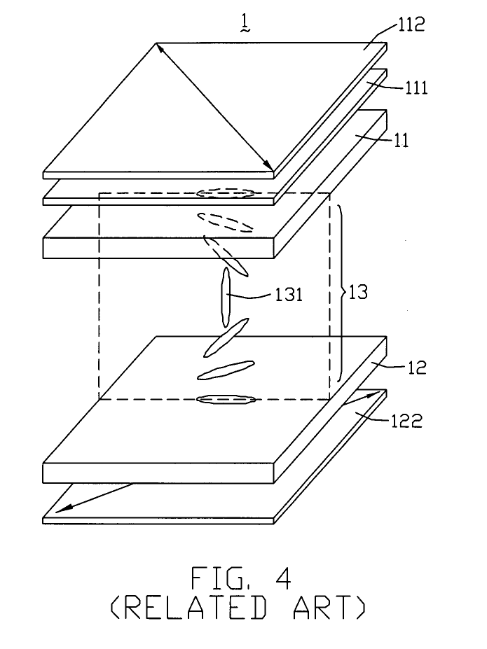

FIG. 5 is a side cross-sectional view of the OCB mode LCD device of FIG. 4 when assembled, showing an exemplary splay alignment state of liquid crystal molecules thereof on the left side, and an exemplary bend alignment state of liquid crystal molecules thereof on the right side.

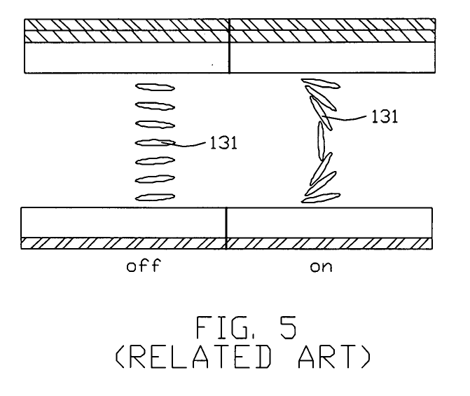

### DETAILED DESCRIPTION OF PREFERRED EMBODIMENTS

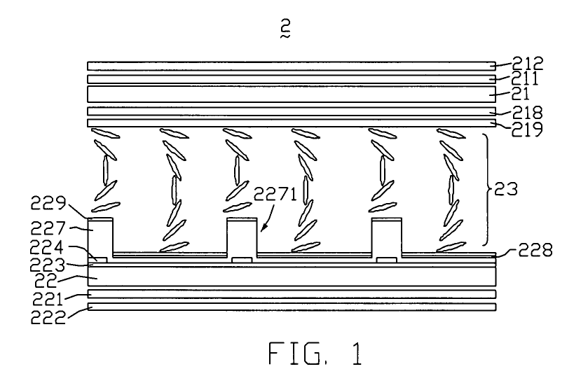

Referring to FIG. 1, this is a schematic, side cross-sectional view of part of an OCB mode LCD device 2 according to a first embodiment of the present invention. The LCD device 2 includes a first substrate 21, a second substrate 22 disposed parallel to and spaced apart from the first substrate 21, and a liquid crystal layer 23 having liquid crystal molecules (not labeled) sandwiched between the substrates 21 and 22.

A first biaxial compensation film 211 and a first polarizer 212 are disposed at an outer surface of the first substrate 21 that is farthest from the liquid crystal layer 23. A common electrode 218 and a first alignment layer 219 are disposed at an inner surface of the first substrate 21 that is nearest to the liquid crystal layer 23.

A second biaxial compensation film 221 and a second polarizer 222 are disposed at an outer surface of the second substrate 22 that is farthest from the liquid crystal layer 23. An insulating layer 223, a passivation layer 227, and a second alignment layer 229 are disposed at an inner surface of the second substrate 22 that is nearest to the liquid crystal layer 23.

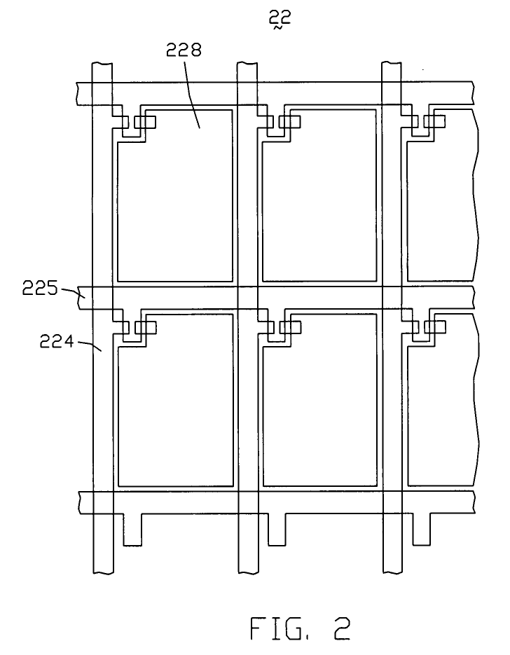

Also referring to FIG. 2, an enlarged, top plan view of a corresponding part of the second substrate 22 is shown. A plurality of gate lines 224 is formed between the passivation layer 227 and the insulating layer 223. The gate lines 224 correspond in position to non-display regions of the LCD device 2. The gate lines 224 are parallel to each other and each extend along a first direction. A plurality of data lines 225 is also formed at the second substrate 22. The data lines 225 correspond in position to the non-display regions of the LCD device 2. The data lines 225 are parallel to each other and each extend along a second direction orthogonal to the first direction. A grid formed by the crossing gate lines 224 and data lines 225 defines a multiplicity of pixel regions (not labeled). The pixel regions correspond in position to display regions of the LCD device 2. Each pixel region can be considered to span a full thickness of the LCD device 2.

A plurality of separate pixel electrodes 228 is formed between the second alignment layer 229 and the passivation layer 227. The pixel electrodes 228 correspond in position to the display regions of the LCD device 2. The passivation layer 227 forms a plurality of separate rectangular-shaped protrusions 2271. The protrusions 2271 correspond in position to the non-display regions of the LCD device 2. Thus, a height of the passivation layer 227 corresponding to the display regions is different from a height of the passivation layer 227 corresponding to the non-display regions.

The first and second alignment layers 219, 229 both have an alignment direction that is horizontal. The liquid crystal molecules are bend aligned so that the LCD device 2 operates in an optically compensated bend (OCB) mode. A pre-tilt angle of the liquid crystal molecules adjacent to each of the substrates 21 and 22 is in a range of 0° to 15°. A height of the liquid crystal layer 23 in the pixel regions (display regions) is greater than a height of the liquid crystal layer 23 corresponding to the protrusions 2271 of the passivation layer 227 (i.e. at the non-display regions).

With the above-described configuration, the liquid crystal molecules adjacent to (i.e. above) the protrusions 2271 are obliquely aligned relative the profile of the protrusions 2271. Therefore during the transition process of converting the liquid crystal molecules from a splay alignment state into a bend alignment state, the liquid crystal molecules adjacent to the protrusions 2271 are easily converted from their already obliquely aligned state to the bend alignment state. That is, the liquid crystal molecules adjacent to the protrusions 2271 convert fast, because only a slight change in their orientation is needed. In addition, the liquid crystal molecules adjacent to the protrusions 2271 can help actuate other adjacent liquid crystal molecules farther away from the protrusions 2271 to convert to the bend alignment state. That is, the liquid crystal molecules adjacent to the protrusions 2271 and liquid crystal molecules farther away from the protrusions 2271 cooperate to reorient together. Thus, the transition process of all the liquid crystal molecules is fast. Furthermore, once all the liquid crystal molecules in the LCD device 2 are bend-aligned, they have respective pre-tilt angles, which ensures that the liquid crystal molecules can more easily adjust their orientations when a voltage is applied to the LCD device 2 and a change in a driving electric field is effected. Thereby, the LCD device 2 has a fast response time. Moreover, because liquid crystal molecules farther away from the protrusions 2271 are actuated by the liquid crystal molecules adjacent to the protrusions 2271, this helps ensure all the liquid crystal molecules in the liquid crystal layer 23 are converted in the transition process. Thereby, the LCD device 2 avoids exhibiting display defects.

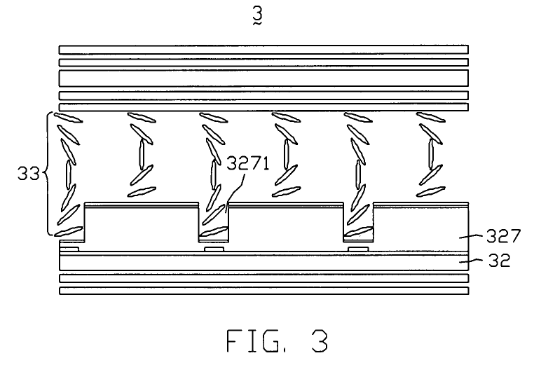

FIG. 3 is a schematic, side cross-sectional view of part of an OCB mode LCD device 3 according to a second embodiment of the present invention. The LCD device 3 is similar to the LCD device 2. However, a passivation layer 327 disposed on the second substrate 32 defines a plurality of separate slits 3271, which correspond in position to non-display regions of the LCD device 3. Thus a height of the passivation layer 327 corresponding to display regions of the LCD device 3 is greater than a height of the passivation layer 327 corresponding to the non-display regions of the LCD device 3. Correspondingly, a height of a liquid crystal layer 33 in pixel regions (display regions) of the LCD device 3 is less than a height of the liquid crystal layer 33 corresponding to the slits 3271 of the passivation layer 327 (i.e. at the non-display regions).

Various modifications and alterations of the above-described embodiments are possible. For example, each compensation film may instead be a uniaxial compensation film, an A-plate compensation film, or a discotic molecular film. In another example, each protrusion may have a triangular, trapezoidal, semicircular, or curved shape.

It is to be further understood that even though numerous characteristics and advantages of the present embodiments have been set out in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A liquid crystal display device, comprising:
a first substrate and a second substrate;
a liquid crystal layer having liquid crystal molecules interposed between the first and second substrates, the liquid crystal molecules being bend-aligned such that the liquid crystal display device is able to operate in an optically compensated bend (OCB) mode;
a first alignment layer disposed between the liquid crystal layer and the first substrate, and a second alignment layer disposed between the liquid crystal layer and the second substrate; and
a passivation layer disposed between the second alignment layer and the second substrate, the passivation layer having different heights.

2. The liquid crystal display device as claimed in claim 1, further comprising a plurality of gate lines and a plurality of data lines formed on the second substrate, the gate lines being parallel to each other and each extending along a first direction, and the data lines being parallel to each other and each extending along a second direction orthogonal to the first direction.

3. The liquid crystal display device as claimed in claim 2, wherein a grid formed by the crossing gate lines and data lines defines a plurality of pixel regions corresponding to display regions of the liquid crystal display device, and the gate lines and the data lines correspond to non-display regions of the liquid crystal display device.

4. The liquid crystal display device as claimed in claim 3, wherein the passivation layer forms a plurality of separate protrusions corresponding to the non-display regions.

5. The liquid crystal display device as claimed in claim 4, wherein a height of the liquid crystal layer corresponding to the display regions is greater than a height of the liquid crystal layer corresponding to the non-display regions.

6. The liquid crystal display device as claimed in claim 4, wherein each protrusion has a rectangular shape.

7. The liquid crystal display device as claimed in claim 4, wherein each protrusion has a triangular shape.

8. The liquid crystal display device as claimed in claim 4, wherein each protrusion has a trapezoidal shape.

9. The liquid crystal display device as claimed in claim 4, wherein each protrusion has a semicircular shape.

10. The liquid crystal display device as claimed in claim 3, wherein the passivation layer defines a plurality of separate slits corresponding to the non-display regions.

11. The liquid crystal display device as claimed in claim 10, wherein a height of the liquid crystal layer corresponding to the display regions is less than a height of the liquid crystal layer corresponding to the non-display regions.

12. The liquid crystal display device as claimed in claim 1, wherein the first and second alignment layers each have a horizontal alignment direction, and a pre-tilt angle of a plurality of the liquid crystal molecules that are adjacent to each of the first and second substrates is in a range of 0° to 15°.

13. A liquid crystal display device, comprising:
a first substrate and a second substrate;
a liquid crystal layer having liquid crystal molecules interposed between the first and second substrates, the liquid crystal molecules being bend-aligned such that the liquid crystal display device is able to operate in an optically compensated bend (OCB) mode; and
a plurality of gate lines being parallel to each other and each extending along a first direction, and a plurality of data lines being parallel to each other and each extending along a second direction orthogonal to the first direction, the crossing gate lines and data lines defining a plurality of pixel regions corresponding to display regions of the liquid crystal display device, and the gate lines and the data lines corresponding to non-display regions of the liquid crystal display device;
wherein a height of the liquid crystal layer in the display regions is different from a height of the liquid crystal layer in the non-display regions.

14. The liquid crystal display device as claimed in claim 13, further comprising a passivation layer at the second substrate, the passivation layer having different heights respectively complementary to the different heights of the liquid crystal layer.

15. The liquid crystal display device as claimed in claim 14, wherein the passivation layer forms a plurality of separate protrusions corresponding to the non-display regions.

16. The liquid crystal display device as claimed in claim 15, wherein a height of the liquid crystal layer corresponding to the display regions is greater than a height of the liquid crystal layer corresponding to the non-display regions.

17. The liquid crystal display device as claimed in claim 14, wherein the passivation layer forms a plurality of separate slits corresponding to the non-display regions.

18. The liquid crystal display device as claimed in claim 17, wherein a height of the liquid crystal layer corresponding to the display regions is less than a height of the liquid crystal layer corresponding to the non-display regions.

19. A liquid crystal display device, comprising:
a first substrate and a second substrate; and
a liquid crystal layer having liquid crystal molecules interposed between the first and second substrates, the liquid crystal molecules being bend-aligned such that the liquid crystal display device is able to operate in an optically compensated bend (OCB) mode; wherein
the liquid crystal layer defines different heights.

20. The liquid crystal display device as claimed in claim 19, wherein the different heights of said liquid crystal layer are arranged in a stepped manner.
